(19) United States
(12) Patent Application Publication
(10) Pub. No.: US 2007/0200967 A1
(43) Pub. Date: Aug. 30, 2007

(54) Method of making a polarizer and method of making a polarizing sheet

(76) Inventors: Chung-Neng Fu, Taoyuan County (TW); Cheng-Hsin Tsai, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/743,155

(22) Filed: May 2, 2007

Related U.S. Application Data
(63) Continuation-in-part of application No. 11/164,826, filed on Dec. 7, 2005.
(63) Continuation-in-part of application No. 11/397,403, filed on Apr. 4, 2006.

(30) Foreign Application Priority Data
Feb. 9, 2007 (TW) 096104788
Nov. 15, 2005 (TW) 094140099

(51) Int. Cl. B29D 7/01; G02F 1/136

(52) U.S. Cl. 349/43; 264/1.34; 264/78

(57) ABSTRACT

A method of making a polarizer and a polarizing sheet is disclosed. The method of making a polarizer comprises providing a polyvinyl alcohol (PVA) film; dipping the PVA film into a first solution to perform a pre-treatment, wherein the first solution contains a carboxylic acid having at least two carboxyl groups or a derivative thereof and a catalyst catalyzing the reaction between the carboxylic acid and the surface of the PVA film; dipping the pretreated PVA film into a dye solution to perform a dyeing; dipping the dyed PVA film into a second solution while stretching the PVA film, wherein the second solution contains boric acid; and drying the stretched PVA film to form a polarizer.

### CROSS REFERENCE TO RELATED APPLICATIONS

This is a continuation-in-part of U.S. application Ser. No. 11/397,403 filed Apr. 4, 2006 and U.S. application Ser. No. 11/164,826 filed Dec. 7, 2005.

### BACKGROUND OF THE INVENTION

1. Field of the Invention

The present invention generally relates to the manufacture of a polarizer and a polarizing sheet and, more particularly, to a method for manufacturing a polarizer used in a polarizing sheet of a liquid crystal display (LCD).

2. Description of the Prior Art

Polarizer is one of essential components in LCDs, which polarizes a laterally oscillating light into a linearly polarized light. The polarized light and the twisting nature of liquid crystal molecules are combined to control the passage of light and the performance of the color signal. Today, LCDs are widely used in cell phones, watches, calculators, personal computers, monitors, electronic clocks, word-processors, automobiles, liquid crystal televisions, outdoor commercial displays, in-car GPS screens, navigation systems of vehicles, and satellites. The market demand for polarizing sheets has increased with the increased use of such liquid-crystal display devices.

FIG. 1 is a schematic, cross-sectional diagram of a conventional polarizing sheet 10. Typically, the polarizing sheet 10 includes a polyvinyl alcohol (PVA) polarizing base film 12 serving as a polarizer, protective films 14 and 16 formed of triacetyl cellulose (TAC) covering the top and bottom sides of the polarizer. The polarizing sheet 10 may further comprise a pressure-sensitive adhesive film 18, an adhesive release film 20, and a protective film 22. In some cases, an anti-glare coating, or an anti-reflection coating may be applied on the protective film 16. Currently, the iodine-type polarizing sheet is more prevalent than other types because of its high optical performance (including high light transmittance, high contrast and wide range of wavelengths), easy production process and low cost.

Conventionally, the manufacture of the iodine-type polarizing sheet is carried out by swelling a PVA film in water, dyeing the PVA film in the dyeing solution containing iodine and potassium iodide, stretching the PVA film in a solution containing boric acid and potassium iodide, optionally color-fixing the PVA film in the solution containing boric acid and potassium iodide and rinsing, then drying the PVA film in an oven to form the PVA polarizing base film 12, which functions as a polarizer. Thereafter, the PVA polarizing base film 12 is laminated with the protective films 14 and 16 through a hydrogel layer applied on two opposite sides of the PVA polarizing base film 12. After drying, a three-layered semifinished polarizer is formed. Among these, the boric acid, which is a cross-linking agent, can cross-link with a surface of the PVA film to increase the tenacity of the PVA film and prevent the PVA film from losing iodine and potassium iodide in subsequent dipping processes. Iodine and potassium iodide loss will lead to damages of optical performance of the polarizer (such as polarizing efficiency, transmittance, and b value).

Although the boric acid can act as a cross-linking agent, it also leads to some shortcomings. First, boric acid may increase the tenacity of the PVA film, so the stretching ratio of the PVA film may be normally restricted in a range of 5.5 to 6.0. Second, as boric acid increases the tenacity of the PVA film, the tension that the roller takes during the stretching process will be too much. Usually, the tension is reduced by stretching the PVA film at a relatively high temperature to soften the PVA film. Generally, the stretching temperature of the stretching tank is between 50° C. and 55° C. However, the high temperature will cause the solution in the tank to evaporate rapidly, and accordingly the concentration of the solution will vary too much and iodine in the PVA film will tend to be lost. Meanwhile, the high temperature also increases the loss of iodine and iodide in the dyed PVA film.

Therefore, a better method for manufacturing a polarizer/polarizing sheet is needed to solve the above-mentioned problems, so as to fabricate the polarizer/polarizing sheet with good optical performance.

### SUMMARY OF THE INVENTION

It is one objective of the present invention to provide a method of making a polarizer/polarizing sheet having good optical performance. In addition, the temperature of the stretching tank can be lower than that in the conventional process to solve the above-mentioned problems.

According to the present invention, a method of making a polarizer comprises providing a polyvinyl alcohol (PVA) film; performing a pre-treating process by dipping the PVA film into a first solution, wherein the first solution comprises at least a carboxylic acid containing at least two carboxylic groups or a derivative thereof and a catalyst catalyzing a surface reaction between the carboxylic acid and the PVA film; performing a dyeing process by dipping the pre-treated PVA film into a dye-containing solution; dipping the dyed PVA film into a second solution and stretching the PVA film simultaneously, wherein the second solution comprises boric acid; and drying the stretched PVA film to form a polarizer.

According to the present invention, a method of making a polarizing sheet, comprises providing a polyvinyl alcohol (PVA) film; performing a pre-treating process by dipping the PVA film into a first solution, wherein the first solution comprises at least a carboxylic acid containing at least two carboxylic groups or a derivative thereof and a catalyst catalyzing a surface reaction between the carboxylic acid and the PVA film; performing a dyeing process by dipping the pre-treated PVA film into a dye-containing solution; dipping the dyed PVA film into a second solution and stretching the PVA film simultaneously, wherein the second solution comprises boric acid; drying the stretched PVA film to form a polarizer; and laminating the dried polarizer with at least a protective film to form a polarizing sheet.

The term “polarizer” or also called “polarizing film” herein refers to as a film or layer having a polarizing function among all layers of a polarizing sheet. For example, a polarizer contains iodine or dichroic dyestuffs.

According to the present invention, the method of making a polarizer/polarizing sheet includes using a carboxylic acid containing at least two carboxylic groups or a derivative thereof to cross-link the PVA film, and, thereafter, dyeing the cross-linked PVA film. Because the PVA film is cross-linked before the dyeing process, the polarizer/polarizing sheet obtained in the present invention has advantages below:

(1) The process taught in the present invention can be integrated into or interchanged with the conventional process easily.

(2) Color losing in the polarizer can be prevented.

(3) The temperature of the stretching tank can be decreased, so the parameters of the process can be adjusted more flexibility.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic, cross-sectional structural diagram of a conventional polarizing sheet.

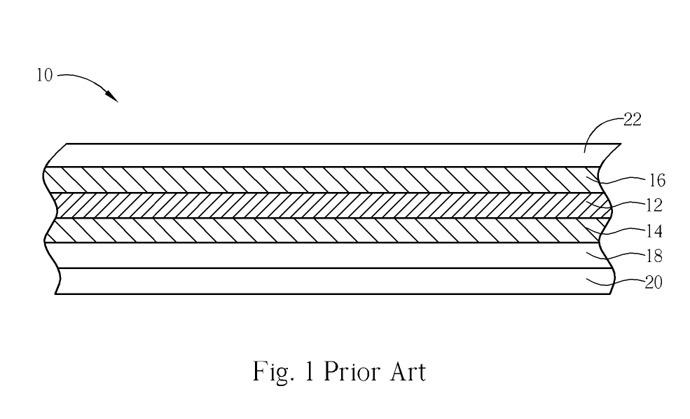

FIG. 2 shows a schematic diagram of the fabricating method of a polarizer/a polarizing sheet according to the present invention.

FIG. 3 is a diagram of a surface configuration of the PVA film after the treatment with a dicarboxylic acid.

FIG. 4 is a diagram showing the disposition of tanks for making a polarizer according to the prior art.

FIG. 5 is a table showing the test results of the polarizers obtained from the two preferred embodiments and the three comparison embodiments.

### DETAILED DESCRIPTION

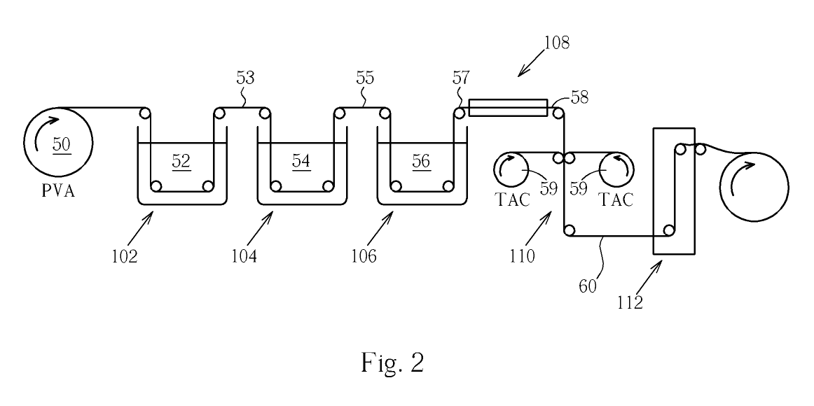

According to the present invention, a method of making a polarizer comprises providing a polyvinyl alcohol (PVA) film; performing a pre-treating process by dipping the PVA film into a first solution, wherein the first solution comprises at least a carboxylic acid containing at least two carboxylic groups or a derivative thereof and a catalyst catalyzing a surface reaction between the carboxylic acid and the PVA film; performing a dyeing process by dipping the pre-treated PVA film into a dye-containing solution; dipping the dyed PVA film into a second solution and stretching the PVA film simultaneously, wherein the second solution comprises boric acid; and drying the stretched PVA film to form a polarizer. Please refer to FIG. 2, showing an embodiment of the present invention.

FIG. 2 shows an embodiment of making a polarizer and further making a polarizing sheet. The process generally includes the following steps:

Step 102: pre-treatment;

Step 104: dyeing;

Step 106: stretching;

Step 108: drying;

Step 110: lamination; and

Step 112: drying.

Steps 102, 104, 106 and 108 are primary steps in the method of making a polarizer according to the present invention. The rinsing process can be optionally performed several times before or after dyeing or stretching. Polarizing sheets can be obtained by further performing the lamination of step 110. Drying of Step 112 can be performed after Step 110.

In Step 102, an un-stretched PVA film 50 is pre-treated by dipping in the first solution 52. The first solution 52 includes at least a carboxylic acid containing at least two carboxylic groups or a derivative thereof and a catalyst catalyzing a surface reaction between the carboxylic acid and the PVA film. The tank which contains the first solution 52 to perform the pre-treating process is herein called the pre-treating tank. The surface of the PVA film is treated by a dicarboxylic acid before dyeing, so as to improve the stretching ability of the PVA film.

The carboxylic acid containing at least two carboxylic groups or derivatives thereof may be any organic acid or a derivative thereof having two carboxylic groups, such as ethanedioic acid, propanedioic acid, butanedioic acid, glutaric acid, adipic acid, or pimelic acid, or a derivative thereof. In other words, any carboxylic acid containing at least two carboxylic groups or the derivatives thereof can be used in the present invention. The salt of carboxylic acid containing at least two carboxylic groups or the derivatives thereof can be used as well, but acid needs to be added to make the first solution become acidic.

Taking adipic acid as an example, adipic acid having a molecular formula as HOOCC₄H₈COOH is a dicarboxylic acid comprising six carbon atoms, thus it has different configurations in space. Considering molecular characteristics, solubility in water and gaining source, adipic acid is one of suitable carboxylic acids for the present invention.

The amount of the carboxylic acid containing at least two carboxylic groups or a derivative thereof is not particularly limited, as long as the carboxylic acid or the derivative could form bonds with the surface of the PVA film and is fully dissolved in the first solution at a pre-set temperature. For example, the concentration of the dicarboxylic acid may be in a range of 1 weight % to 4 weight %, and preferably 2 weight % to 3 weight %, based on the total weight of the first solution. The temperature of the pre-treating tank can be adjusted as desired without particular limitation. In one embodiment of the present invention, the temperature of the pre-treating tank can be in a range of 25° C. to 40° C. and preferably 30° C. to 40° C. e

The catalyst may be a Lewis acid, such as zinc ions (Zn²⁺) or aluminum ions (Al³⁺), or any salt or complex which can provide Zn²+ or Al³⁺, such as ZnCl₂, AlCl₃, Al₂(SO₄)₃, ZnSO₄, and the like. Because the size of the pre-treating tank, the concentration of the carboxylic acid, the location of the roller and the temperature of the tank solution are changeable parameters, the amount of the catalyst is not particularly limited, as long as the carboxylic groups can bond with the PVA film. If the carboxylic acid reacts with the PVA film, the stretching ability of the PVA film will be increased obviously. Therefore, the stretching ratio which cannot be achieved by conventional processes can be reached by the method according to the present invention. Taking Al₂(SO₄)₃·18H₂O as the source of the Al³⁺, the concentration of Al³⁺can be in a range of 0.01 weight % to 5 weight %, preferably 0.01 weight % to 3 weight %, and more preferably 0.01 weight % to 1 weight %, based on the total weight of the first solution.

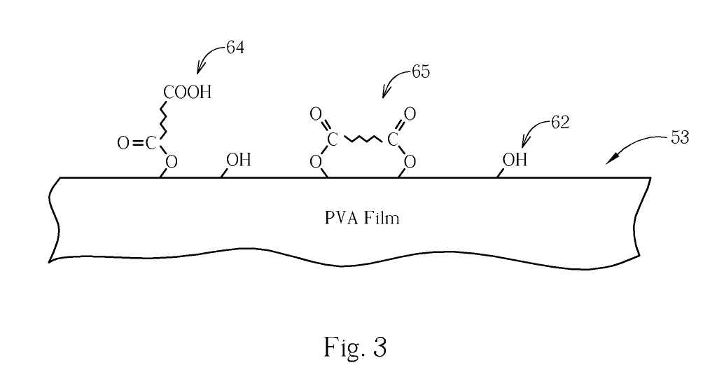

Please refer to FIG. 3. FIG. 3 is a schematic diagram of the surface configuration of the PVA film 53 after the pretreatment in Step 102. Taking adipic acid as an example, in Step 102, adipic acid has two carboxyl groups at two ends of the molecular chain respectively, and one of the carboxyl groups is esterified with a hydroxyl group 62 on the surface of the PVA film to form a chemical bonding structure 64, or both carboxyl groups of the adipic acid molecule are esterified with the hydroxyl groups 62 on the surface of the PVA film respectively to form a chemical bonding structure 65.

The pre-treating process is preformed before the dyeing process, thus the potassium iodide which is an expensive component is not needed in the first solution. The un-stretched PVA film may be swelled in pure water before the pre-treating process.

The PVA film 53 pre-treated in Step 102 is dyed in Step 104 by dipping in a dyeing solution 54 such as a solution containing iodine to adsorb iodine. The dyeing solution 54 containing iodine basically contains molecular iodine and potassium iodide with an iodine concentration (including molecular iodine and ionic iodine) of 0.01 weight % to 1 weight %. The dyeing solution 54 may further comprise boric acid.

The present invention is not limited to the fabrication of polarizing sheets containing iodine, and thus in Step 104 the dye can be dichroic dyestuffs such as organic dyes and the like, other than iodine.

Next, the PVA film may be rinsed optionally in a first rinsing tank containing a solution of boric acid and potassium iodide after dyeing process and before stretching process. The rinsing process is similar to the conventional art.

In Step 106, the dyed PVA film 55 is stretched by, for example, a uniaxial stretching process in a stretching solution 56 containing boric acid and potassium iodide. The concentration of boric acid may be the concentration used in the conventional process, for example, 1 weight % to 10 weight %, and the concentration of potassium iodide may be the concentration used in the conventional process, for example, 1 weight % to 10 weight %. The concentrations of boric acid and potassium iodide contained in a stretching solution usually need to be monitored during the stretching process. In the present invention, it is easy to determine the quantity of the boric acid and the potassium iodide without any problem.

The PVA film after the stretching process may be further rinsed optionally. For example, the PVA film can be rinsed in a second rinsing tank as usually used in a conventional process, and then the PVA film may undergo a color fixation in a fixation tank optionally. The second rinsing tank and the fixation tank may comprise potassium iodide and boric acid, and the concentration thereof can be adjusted as desired. The preferred concentration may be about 1 weight % to 5 weight % respectively. The concentration ratio of both tanks between potassium iodide and boric acid is usually equal to that in the stretching tank, and thus properties of PVA film can be further improved. The rinsing process may be performed again by requirements. A third rinsing tank used in a conventional process may be used to rinse the PVA film. Cold water around 10° C. or lower may be used as a rinsing solution to remove chemical residue on the surface of the PVA film, before the PVA film is dried.

Next, Step 108 can be further carried out to dry the stretched PVA film 57 to form the PVA film 58, that is, the polarizer made by the method according to the present invention. There is no particular limitation to the method for drying the PVA film, and the PVA film can be dried by hot air or IR (infrared ray).

In Step 110, at least a protective film 59 are laminated with the PVA film 58 which is treated in Step 108 to form a film stack for making a polarizing sheet. The protective layer may include triacetyl cellulose (TAC) films, diacetyl cellulose (DAC) films, polyethylene terephthalate (PET) films, cyclicolefin polymer (COP) films, cyclicolefin copolymer (COC) films, polycarbonate (PC) films, or the like.

Finally, in Step 112, the film stack 60 is subjected to a drying process, such as drying at a temperature of 50° C. to 80° C., to form a polarizing sheet. There is no particular limitation to the method for drying, and hot air or IR (infrared ray) may be used.

Furthermore, to improve the function of the polarizing sheet, the protective layer may be coated with, for example, a liquid crystal layer, a protective layer, an anti-glare layer, an anti-reflection layer, an anti-scratch layer, an anti-smear layer, and the like. By combining the protective films with different functions, the polarizing sheets with different optical performances can be obtained.

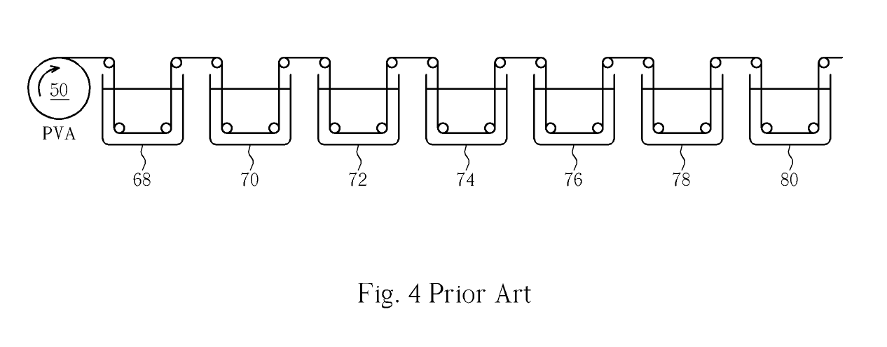

To explain the features and advantages of the present invention further, two preferred embodiments and three comparison embodiments are demonstrated as below. The process according to the present invention can be integrated into the conventional process easily, therefore, disposition of tanks in the preferred embodiments are based on the conventional art. The disposition of the tanks and the rollers shown in FIG. 4 is only a simple schematic diagram, and the disposition thereof can be varied as desired.

### EMBODIMENTS

### First Preferred Embodiment

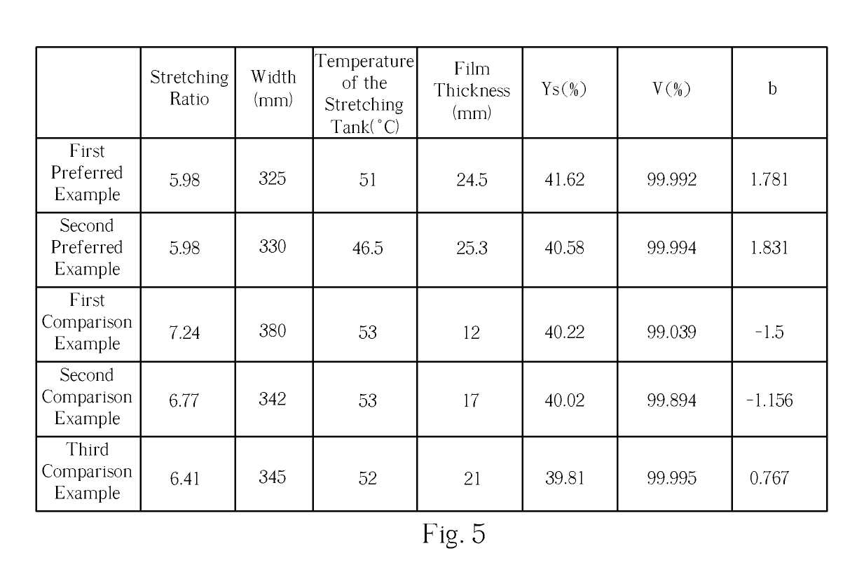

Please refer to FIG. 4. FIG. 4 is a schematic diagram showing the disposition of tanks according to the conventional art. The unstretched PVA film 50 (width 650 mm, thickness 75 μm) was transferred by the rollers. First, the PVA film 50 was swelled in the tank 68 with pure water at 28° C., and pretreated in the pre-treating tank 70 at 30° C. The solution in the tank 70 contained 2.25 weight % of adipic acid and 0.3 weight % of Al₂(SO₄)₃·16-18H₂O. After the pre-treating process, the PVA film 50 was dyed in the tank 72 containing an iodine solution at 30° C. The iodine solution comprised 0.033 weight % of iodine, 0.95 weight % of boric acid, and 0.6 weight % to 0.8 weight % of potassium iodide. Next, the dyed PVA film was stretched in the stretching tank 74 containing a stretching solution at 51° C. The stretching solution contained 3.35 weight % of boric acid and 3.01 weight % of potassium iodide. Subsequently, the PVA film was rinsed in a rinsing solution of the second rinsing tank 76, and the rinsing solution was at 40° C. and contained 3.27 weight % of boric acid and 4.19 weight % of potassium iodide. Next, color fixation was performed in a color fixation tank 78. The color fixation solution therein was at 40° C. and contained 3.14 weight % of boric acid and 3.86 weight % of potassium iodide. Then the PVA film was further rinsed in the third rinsing tank 80 containing water at 10° C. Finally, the PVA film was dried at 60° C. to form a polarizer. The stretching ratio, width (mm), thickness (μm), polarizing efficiency (V, %), transmittance (Ys, %), and b value of Hue of the polarizer were determined and the results are shown in FIG. 5.

### Second Preferred Embodiment

The same method as that described in the First Preferred Embodiment was used to fabricate a polarizer, except that the solution in the tank 70 was at 35° C. and the stretching solution was at 46.5° C. The stretching ratio, width (mm), thickness (μm), polarizing efficiency (V, %), transmittance (Ys, %), and b value of Hue of the polarizer obtained were determined and are shown in FIG. 5.

### First Comparison Embodiment

Please refer to FIG. 4. The unstretched PVA film 50 (width 650 mm, thickness 75 μm) was transferred by the rollers and swelled in the tank 68 which served as a swelling tank by pure water at 30° C. and then dyed in the tank 70 which served as a dyeing tank by iodine solution at 30° C. The iodine solution comprised 0.048 weight % of iodine, 1 weight % of boric acid and 1.5 weight % of potassium iodide. The dyed PVA film was put in the first rinsing tank 72 at 35° C. and the rinsing solution contained 3 weight % of boric acid and 3 weight % of potassium iodide. Then, the rinsed PVA film was stretched in the stretching tank 74, and the stretching solution therein contained 3 weight % of adipic acid, 1 weight % of boric acid, 0.14 weight % of ZnCl₂ and 4 weight % of KI, and the temperature of the stretching solution was at 53° C. Following that, rinsing the PVA film in the second rinsing tank 76, the second rinsing solution was at 30° C. and contained 3 weight % of boric acid and 4 weight % of potassium iodide. Next, color fixation was performed in the color fixation tank 78, the color fixation solution was at 30° C. and contained 3 weight % of boric acid and 4 weight % of potassium iodide. Then rinsing the PVA film in the third rinsing tank 80 containing water at 10° C. Following that, the PVA film was finally dried at 60° C. to form polarizers. The stretching ratio, width (mm), thickness (μm), polarizing efficiency (V, %), transmittance (Ys, %), and b value of Hue of the polarizer are shown in FIG. 5.

### Second Comparison Embodiment

Please refer to FIG. 4. The unstretched PVA film 50 (width 650 mm, thickness 75 μm) was transferred by the rollers and swelled in pure water at 30° C. in the tank 68 serving as a swelling tank and dyed in an iodine solution at 30° C. in the tank 70 serving as a dyeing tank. The dyed PVA film was put in the first rinsing tank 72 for rinsing. The rinsing solution was at 35° C. and contained 3 weight % of boric acid and 3 weight % of potassium iodide. Then, the rinsed PVA film was stretched in the stretching tank 74, and the stretching solution therein contained 3 weight % of adipic acid, 1 weight % of boric acid, 0.14 weight %, of ZnCl₂ and 4 weight % of KI, and the temperature of the stretching solution was at 53° C. Following that, the PVA film was rinsed in the second rinsing tank 76. The rinsing solution was at 30° C. and contained 3 weight % of boric acid and 4 weight % of potassium iodide. Next, color fixation was performed in the color fixation tank 78 containing a color fixation solution at 30° C. The color fixation solution contained 3 weight % of boric acid and 4 weight % of potassium iodide. Then the PVA film was further rinsed in the third rinsing tank 80 containing water at 10° C. Finally, the PVA film was dried at 60° C. to form a polarizer. The stretching ratio, width (mm), thickness (μm), polarizing efficiency (V, %), transmittance (Ys, %), and b value of Hue of the polarizer were determined and the results are shown in FIG. 5.

### Third Comparison Embodiment

Please refer to FIG. 4. The unstretched PVA film 50 (width 650 mm, thickness 75 μm) was transferred by the rollers and swelled in pure water at 28° C. in the tank 68 serving as a swelling tank and dyed in an iodine solution at 30° C. in the tank 70 serving as a dyeing tank. The dyed PVA film was dipped in the treating tank 72 containing a treating solution at 39° C. The treating solution contained 2.5 weight % of adipic acid, 0.3 weight % of Al₂(SO₄)₃·16-18H₂O, and 3.3 weight % of KI. Then, the treated PVA film was stretched in the stretching tank 74, and the stretching solution therein contained 3.49 weight % of boric acid and 4.13 weight % of KI, and the temperature of the stretching solution was at 52° C. Following that, the stretched PVA film was rinsed in the second rinsing tank 76, the rinsing solution was at 40° C. and contained 3.29 weight % of boric acid and 3.81 weight % of potassium iodide. Next, color fixation was performed in the color fixation tank 78, and the color fixation solution therein was at 40° C. and contained 3.8 weight % of boric acid and 4.3 weight % of potassium iodide. Then the PVA film is rinsed in the third rinsing tank 80 containing water at 10° C. Finally, the PVA film was dried at 60° C. to form a polarizer. The stretching ratio, width (mm), thickness (μm), polarizing efficiency (V, %), transmittance (Ys, %), and b value of Hue of the polarizer were determined and the results are shown in FIG. 5.

From the results as shown in FIG. 5, comparing the First Preferred Embodiment and the Second Preferred Embodiment with the First Comparison Embodiment, the Second Comparison Embodiment and the Third Comparison Embodiment, the width and the stretching ratio do not increase, and the film is thicker for the polarizer obtained using the method according to the present invention. The thicker thickness enables the PVA film not to break easily during the fabricating process. Next, the polarizing efficiency, transmittance and other optical performance are good. Furthermore, the b values are improved to 1.781 and 1.831, respectively. Therefore, the method according to the present invention can easily provide the polarizer with a better b value. By further comparing the First Preferred Embodiment with the Second Preferred Embodiment, it is known that in the case of the same stretching ratio, even other parameters such as the temperature of the stretching tank is altered, the polarizer which does not lose colors can still be made. In other words, the fabricating process according to the present invention is very flexible.

In the First Preferred Embodiment and the Second Preferred Embodiment, the PVA film is treated by adipic acid before dyed. Because there are a lot of hydroxyl groups on the surface of the PVA film, ester bonds can be formed under heating and in a presence of a suitable amount of catalyst. Because the structure of the adipic acid is relatively free, two types of chemical bonding structures 64 and 65 can be formed. The single bonding structure of the adipic acid increases adhesiveness between the PVA film and the protective film in the subsequent lamination process. The double bonding structure of the adipic acid can increase the stretchability of the PVA film, and thus even under high stretching ratio, the PVA film will not break. Higher stretching ratio means higher material utilization. Meanwhile, by using rollers, expanding rollers or other equipments, a thinner and wider polarizer can be obtained.

However, comparing with the conventional cross-linking agent -boric acid, adipic acid can increase the stretching ratio of the PVA film more than boric acid, but the performance of color fixation may be poor. In the First Comparison Embodiment and Second Comparison Embodiment, adipic acid and catalyst are added into the stretching tank with boric acid, thus the PVA film is stretched in the solution containing both adipic acid and boric acid. It is known from the results of the first and second comparison embodiments, that such method provides the polarizer having a high stretching ratio and a wide width, but with poor color fixation and poor optical performance. In the Third Comparison Embodiment, adipic acid and a catalyst are added into the first rinsing tank served as the pre-treating tank, therefore, the stretching ability of the dyed PVA film will be increased by adipic acid. Thereafter, the PVA film is cross-linked with boric acid in the stretching tank, and the leakage of iodine in the PVA film can be prevented. Because the reaction between the PVA film and the adipic acid are performed in a pre-treating tank which is an additional tank, the process can be integrated into the conventional process easily and the cost caused by changing the solution of the tanks can be reduced. However, the PVA film still loses color in the following rinsing step.

In other words, in the situation that the PVA film is treated by a dicarboxylic acid after the PVA film is dyed, because the dicarboxylic acid provides a poorer color fixation ability for PVA film than boric acid, the iodine which is dyed into the PVA film will tend to lose during subsequent rinsing processes, causing damage to the optical performance.

In the present invention, the PVA film is treated by a dicarboxylic acid before the dyeing step to prevent color losing. A pre-treating tank is positioned before the dyeing tank, and the pre-treating solution contains a dicarboxylic acid and a catalyst. The PVA film is treated with a carboxylic acid containing at least two carboxylic groups or a derivative thereof to improve the stretching ability. After that, the PVA film is dyed, stretched in the stretching tank (containing boric acid and potassium iodide), color fixed in the color fixation tank (containing boric acid and potassium iodide), rinsed with pure water in the rinsing tank and dried to form a polarizer. The method according to the present invention can be integrated into the conventional process easily, and because the PVA film is treated by a carboxylic acid containing at least two carboxylic groups or a derivative thereof before the dyeing step; therefore, the color losing can be prevented even the polarizer is treated in the boric acid for a short period of time. In addition, the stretching ability of the PVA film is increased so the temperature of the stretching solution can be decreased; thus the solution in the tank will not evaporate too quickly during the stretching process. However, because the adipic acid is not used for treating the PVA film during stretching or before stretching, the adipic acid has a lower contribution in increasing the stretching ability of the PVA film. So the polarizer obtained has a smaller width but a thicker thickness. By using boric acid, the color losing can be prevented, and thus a polarizer with better optical performance can be obtained. Furthermore, the stretching ability can be further increased by adjustment of other parameters such as the temperature of the pre-treating tank, location of the rollers, and stretching parameters. Therefore, the method according to the present invention still has a lot of advantages because the cross-linking reaction is carried out on the PVA film before the dyeing process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of making a polarizer, comprising:
providing a polyvinyl alcohol (PVA) film;
performing a pre-treating process by dipping the PVA film into a first solution, wherein the first solution comprises at least a carboxylic acid containing at least two carboxylic groups or a derivative thereof and a catalyst catalyzing a surface reaction between the carboxylic acid and the PVA film;
performing a dyeing process by dipping the pre-treated PVA film into a dye-containing solution;
dipping the dyed PVA film into a second solution and stretching the dyed PVA film simultaneously, wherein the second solution comprises boric acid; and
drying the stretched PVA film to form a polarizer.

2. The method according to claim 1, wherein the carboxylic acid comprises ethanedioic acid, propanedioic acid, butanedioic acid, glutaric acid, adipic acid, or pimelic acid.

3. The method according to claim 1, wherein the catalyst comprises a Lewis acid.

4. The method according to claim 3, wherein the Lewis acid comprises a zinc ion, an aluminum ion, a metal salt having a zinc or an aluminum ion, or a metal complex having a zinc or an aluminum ion.

5. The method according to claim 1, wherein the dye-containing solution comprises a dichroic dyestuff.

6. The method according to claim 5, wherein the dichroic dyestuff comprises iodine or organic dye molecules.

7. The method according to claim 1, wherein the second solution further comprises potassium iodide.

8. The method according to claim 1, further comprising a rinsing process to rinse the dyed PVA film after the dyeing process and before the stretching.

9. The method according to claim 8, wherein the rinsing process is performed in a solution containing boric acid and potassium iodide.

10. The method according to claim 1, further comprising a swelling process to swell the PVA film before the pre-treating process.

11. A method of making a polarizing sheet, comprising:
providing a polyvinyl alcohol (PVA) film;
performing a pre-treating process by dipping the PVA film into a first solution, wherein the first solution comprises at least a carboxylic acid containing at least two carboxylic groups or a derivative thereof and a catalyst catalyzing a surface reaction between the carboxylic acid and the PVA film;
performing a dyeing process by dipping the pre-treated PVA film into a dye-containing solution;
dipping the dyed PVA film into a second solution and stretching the dyed PVA film simultaneously, wherein the second solution comprises boric acid;
drying the stretched PVA film to form a polarizer; and
laminating the dried polarizer with at least a protective layer to form a polarizing sheet.

12. The method according to claim 11, wherein the carboxylic acid comprises ethanedioic acid, propanedioic acid, butanedioic acid, glutaric acid, adipic acid, or pimelic acid.

13. The method according to claim 11, wherein the catalyst comprises a Lewis acid.

14. The method according to claim 13, wherein the Lewis acid comprises a zinc ion, an aluminum ion, a metal salt having a zinc or an aluminum ion, or a metal complex having a zinc or an aluminum ion.

15. The method according to claim 11, wherein the dye-containing solution comprises a dichroic dyestuff.

16. The method according to claim 15, wherein the dichroic dyestuff comprises iodine or organic dye molecules.

17. The method according to claim 11, wherein the second solution further comprises potassium iodide.

18. The method according to claim 11, further comprising a rinsing process to rinse the dyed PVA film after the dyeing process and before the stretching.

19. The method according to claim 18, wherein the rinsing process is performed in a solution containing boric acid and potassium iodide.

20. The method according to claim 11, further comprising a swelling process to swell the PVA film before the pre-treating process.

21. The method according to claim 11, wherein the protective film comprises triacetyl cellulose (TAC), diacetyl cellulose (DAC), polyethylene terephthalate (PET), cyclicolefin polymer (COP), cyclicolefin copolymer (COC), or polycarbonate (PC).
